(19) United States
(12) Patent Application Publication
(10) Pub. No.: US 2011/0039684 A1
(43) Pub. Date: Feb. 17, 2011

(54) FUSED CERAMIC PRODUCT, METHOD OF FABRICATION AND USES

(75) Inventors: Emmanuel Nonnet, Sarrians (FR); Yves Boussant-Roux, Montfavet (FR); Eric Hanus, Manosque (FR)

Correspondence Address: OLIFF & BERRIDGE, PLC, P.O. BOX 320850, ALEXANDRIA, VA, 22320-4850, US

(73) Assignee: Saint-Gobain Centre De Recherches Et D'etudes Europeen

(21) Appl. No.: 12/746,871

(22) PCT Filed: Dec. 22, 2008
(86) PCT No.: PCT/FR08/52394

§ 371 Date: Oct. 7, 2010

(30) Foreign Application Priority Data
Dec. 20, 2007 (FR) 0760155

(51) Int. Cl. C04B 35/505; C04B 35/49; C04B 35/04

(52) U.S. Cl. 501/135; 501/152; 501/134

(57) ABSTRACT

A molten product in the form of a particle having a sphericity higher than or equal to 0.6, having the following chemical composition, in weight percent based on the oxides and for a total of 100%:
(ZrO₂+HfO₂): complement to 100%,
6%≦CeO₂≦31%,
0.8%≦Y₂O₃≦8.5%,
0%≦Al₂O₃≦30%,
0%≦SiO₂≦17%,
0≦TiO₂≦8.5%,
0≦MgO≦6%, and
other oxides≦1%,
   provided that, by denoting by “C” the weight ratio CeO₂/(ZrO₂+HfO₂) and by “Y” the weight ratio Y₂O₃/(ZrO₂+HfO₂),
0≦C≦0.6 and Y≦0.02 and

Min(63.095*Y²−11.214*Y+0.4962; 0.25)≦C (I) and

C≦250*Y²−49.1*Y+2.6 (II).

### TECHNICAL FIELD

The present invention relates to ceramic products obtained by fusion, or “molten products”, and in particular molten particles usable in particular in apparatus and methods for microgrinding, microdispersion in wet medium and for surface treatment.

It also relates to a method for fabricating such products.

### PRIOR ART

Apparatus and methods for microgrinding, microdispersion in wet medium and surface treatment are well known, and are developed in particular in industries such as:
the mining industry, which uses particles for fine grinding of dry preground materials by conventional methods, in particular for grinding calcium carbonate, titanium dioxide, gypsum, kaolin, iron ore, ores of precious metals and, in general, all ores undergoing a chemical or physicochemical treatment;
the paint, ink, dye, magnetic lacquer, agrochemical compound industries, which use particles for the dispersion and homogenization of the various liquid and solid constituents;
the surface treatment industry, which relies on particles in particular for cleaning operations on metal molds (for the fabrication of bottles, for example), deburring of parts, descaling, preparation of a support for a coating, surface finishing (for example satin finishing of steel), shot peening, or peen forming.

The particles conventionally used for these markets are generally substantially spherical and between 0.005 and 4 mm in size. Depending on the intended markets, they may have one or more of the following properties:
chemical and dye inertia with regard to the products treated,
impact strength,
wear resistance,
low abrasiveness to equipment, particularly stirring members and tanks, or projection members, and
low open porosity for easy cleaning.

In the field of grinding, various types of particles are encountered, particularly sand with rounded grains, glass balls, particularly vitroceramized glass balls, or even metal balls.

Sand with rounded grains, like Ottawa sand for example, is a natural and inexpensive product, but unsuitable for modern grinders, which are pressurized and have high throughputs. This is because the sand has little strength, low density, is of variable quality and is abrasive for the equipment.

Glass balls, widely used, have better strength, lower abrasiveness and are available in a wider range of sizes.

Vitroceramized glass balls, like those described in JP-S61-168552 or JP-S59-174540, are stronger than ordinary glass balls.

Metal balls, particularly of steel, have also been known for many years for the abovementioned applications, but their use remains marginal because they often have insufficient chemical inertia to the products treated, in particular causing pollution of the mineral feeds and shading of paints, and an excessively high density demanding special grinders implying high power consumption in particular, substantial overheating and high mechanical loading of the equipment.

Also known are ceramic particles, which have the advantage of better mechanical strength than the glass balls, high density, and excellent chemical inertia. Among these particles, a distinction can be made between:
sintered ceramic particles, obtained by cold shaping of a ceramic powder followed by consolidation by firing at high temperature, and
molten ceramic particles, generally obtained by fusion of a raw material charge, conversion of the melting material to particles, and solidification thereof.

The large majority of molten ceramic particles used in the abovementioned applications have a composition of the zirconia-silica (ZrO₂—SiO₂) type, in which the zirconia is crystallized in monoclinic form and/or partially stabilized (by appropriate additives), and in which the silica, and part of the optional additives, form a matrix binding the zirconia crystals.

These molten ceramic particles offer optimal properties for grinding, that is, good mechanical strength, high density, chemical inertia and low abrasiveness for the grinding equipment.

Molten ceramic particles based on zirconia and their use for grinding and dispersion are described for example in FR 2 320 276, EP 0 662 461 and FR 2 714 905. These documents thus describe the influence of SiO₂, Al₂O₃, MgO, CaO, Y₂O₃, CeO₂ and Na₂O on the main properties of the resulting particles, particularly on the properties of crushed strength and abrasion resistance.

Document EP 0 662 461 describes molten particles of which the mechanical strength increases with the quantity of Y₂O₃ and of which the density, and hence the grinding effectiveness, increase with the quantity of CeO₂.

Although the molten ceramic particles of the prior art are of good quality, the industry always needs products of even higher quality. In fact, the grinding conditions are steadily more demanding.

In particular, a need exists for noble products having good density and wear resistance.

It is an object of the invention to satisfy this need.

### SUMMARY OF THE INVENTION

In a first main embodiment, the invention proposes a molten product having the following chemical composition, in weight percent based on the oxides and for a total of 100%:
(ZrO₂+HfO₂): complement to 100%,
6%≦CeO₂≦31%,
0.8%≦Y₂O₃≦8.5%,
0%≦Al₂O₃≦30%,
0%≦SiO₂≦37%,
0≦TiO₂≦8.5%,
0≦MgO≦6%, and
other oxides≦1%,
   provided that, by denoting by “C” the weight ratio CeO₂/(ZrO₂+HfO₂) and by “Y” the weight ratio Y₂O₃/(ZrO₂+HfO₂),
0≦C≦0.6 and Y≦0.02 and

Min(63.095*Y²−11.214*Y+0.4962; 0.25)≦C (I) and

C≦250*Y²−49.1*Y+2.6

and a molten product in the form of a particle having a sphericity higher than or equal to 0.6, having the following chemical composition, in weight percent based on the oxides and for a total of 100%:
(ZrO₂+HfO₂): complement to 100%,
6%≦CeO₂≦31%,
0.8%≦Y₂O₃≦8.5%,
0%≦Al₂O₃≦30%,
0%≦SiO₂≦37%,
0≦TiO₂≦8.5%,
0≦MgO≦6%, and
other oxides≦1%,
   provided that, by denoting by “C” the weight ratio CeO₂/(ZrO₂+HfO₂) and by “Y” the weight ratio Y₂O₃/(ZrO₂+HfO₂),
0≦≦C0.6 and C≦250*Y²−49.1*Y+2.6 and 0.02≦Y≦0.098 and when Y<0.079,

Min(859.6102*Y³−93.0079*Y²−2.7284*Y+0.3726; 0.25)≦C (VII).

The inventors have discovered that, in the presence of yttrium oxide, the addition of cerium oxide above a threshold content causes a decrease in the wear resistance. They then discovered that the Y ratio modifies this threshold content and determined the conditions above in order to optimize the compromise between density and wear resistance.

As we shall see below, a molten ceramic product according to the invention thus has both a satisfactory density and a good wear resistance.

According to various particular embodiments of the invention, the product may even have one or more of the optional features in the following list of product features:
Preferably,

Min(70.238*Y²−12.393*Y+0.544; 0.25)≦C (Ill) and/or

C≦150*Y²−30.7*Y+1.72 (IV) and/or

Min(−38.095*Y²+0.3571*Y+0.2738; 0.25)≦C (V) and/or

C≦−51.1905*Y²+0.25*Y+0.4826 (VI);
0≦C≦0.6 and C≦250*Y²−49.1*Y+2.6 and 0.02≦Y≦0.098 and when Y<0.082, Min(63.095*Y²−11.214*Y+0.4962; 0.25)≦C;
(0≦C≦0.6 and 0.02≦Y≦0.098) and
   when Y<0.082, Min(70.238*Y²−12.393*Y+0.544; 0.25)≦C, and/or
C≦150*Y²−30.7*Y+1.72, these two conditions being preferably satisfied;
(0≦C≦0.6 and 0.02≦Y≦0.098) and
   when Y<0.089, Min(−38.095*Y²+0.3571*Y+0.2738; 0.25)≦C and/or
   C≦−51.1905*Y²+0.25*Y+0.4826, these two conditions being preferably satisfied;
the weight ratio C is higher than or equal to 0.15, higher than or equal to 0.18, or higher than or equal to 0.20, or higher than or equal to 0.22, or even higher than or equal to 0.24, or even higher than or equal to 0.26, even 0.30 or 0.40 and/or lower than or equal to 0.55, or lower than or equal to 0.50; C may in particular be higher than or equal to 0.2, preferably higher than or equal to 0.3 and preferably lower than or equal to 0.50;
the weight ratio Y is higher than or equal to 0.025, or higher than or equal to 0.030, or higher than or equal to 0.035, or even higher than or equal to 0.040, even higher than or equal to 0.045 or 0.050, and/or lower than or equal to 0.090, or lower than or equal to 0.085, or lower than or equal to 0.080, or even lower than or equal to 0.070, or even lower than or equal to 0.060; Y may in particular be higher than or equal to 0.030, preferably higher than or equal to 0.040, preferably higher than or equal to 0.045 and lower than or equal to 0.090, preferably lower than or equal to 0.080, preferably lower than or equal to 0.060;
preferably, C is higher than or equal to 0.2 and lower than or equal to 0.5 if Y is higher than or equal to 0.030 and lower than or equal to 0.060;
the weight ratio (ZrO₂+HfO₂)/SiO₂ is higher than or equal to 1, or higher than or equal to 1.5, or higher than or equal to 2, or higher than or equal to 4, or higher than or equal to 6, or higher than or equal to 8, or even higher than or equal to 10, even higher than or equal to 14 and/or lower than or equal to 30, or lower than or equal to 25, or even lower than or equal to 20, or even lower than or equal to 15; preferably, the weight ratio (ZrO₂+HfO₂)/SiO₂ is higher than or equal to 1.5, preferably higher than or equal to 4, even more preferably higher than or equal to 10 and lower than or equal to 25, preferably lower than or equal to 20, even more preferably lower than or equal to 15;
the weight ratio Al₂O₃/SiO₂ is higher than or equal to 0.1, or higher than or equal to 0.2, or even higher than or equal to 0.5 and/or lower than or equal to 3.2, or lower than or equal to 2, or lower than or equal to 1.5. Preferably, the weight ratio Al₂O₃/SiO₂ is higher than or equal to 0.2, preferably higher than or equal to 0.5 and lower than or equal to 3.2, preferably lower than or equal to 2;
preferably, the ratio MgO/SiO₂ is higher than 0 and preferably lower than 1, preferably lower than 0.77;
the content of CeO₂, in weight percent based on the oxides, is higher than or equal to 8%, or higher than or equal to 10%, or higher than or equal to 10.5%, or higher than or equal to 12%, or higher than or equal to 15%, or higher than or equal to 17% and/or lower than or equal to 30%, or lower than or equal to 28%, or even lower than or equal to 26%, or lower than or equal to 25%, or even lower than or equal to 20%; but in a nonlimiting embodiment, the content of CeO₂ may also be higher than or equal to 20%;
preferably, the content of CeO₂ is higher than or equal to 10% and the contents of CeO₂ and of Y₂O₃ satisfy the formulas (III) and (IV), and preferably (V) and (VI);
the content of Y₂O₃, in weight percent based on the oxides, is higher than or equal to 1%, or higher than or equal to 1.65%, or higher than or equal to 2%, or even higher than or equal to 2.5%, or even higher than or equal to 3%, or higher than or equal to 3.4%, or higher than or equal to 3.5% and/or lower than or equal to 9%, or lower than or equal to 8%, or lower than or equal to 6.5%, or even lower than or equal to 5.5%, or even lower than or equal to 5%, or lower than or equal to 4.5%, or lower than or equal to 3.7%, or even lower than or equal to 3.6%;
preferably, the content of Y₂O₃ is higher than or equal to 1.65% and lower than or equal to 6.5%, preferably lower than or equal to 4.5% and the contents of CeO₂ and of Y₂O₃ satisfy the formulas (III) and (IV), and preferably (V) and (VI);
preferably, the content of Al₂O₃, in weight percent based on the oxides, is higher than or equal to 0.5%, or higher than or equal to 1%, or higher than or equal to 2%, or higher than or equal to 4% and/or lower than or equal to 25%, or lower than or equal to 20%, or lower than or equal to 15%, or lower than or equal to 12%, or lower than or equal to 10%, or even lower than or equal to 8%;
preferably, the content of SiO₂, in weight percent based on the oxides, is higher than or equal to 0.5%, higher than or equal to 1%, or higher than or equal to 2.5%, or higher than or equal to 3%, or even higher than or equal to 4%, and/or lower than or equal to 30%, or lower than or equal to 20%, or lower than or equal to 17%, or lower than or equal to 16%, or lower than or equal to 14%, or lower than or equal to 12%, or lower than or equal to 10%, or even lower than or equal to 8%;
preferably, the content of TiO₂, in weight percent based on the oxides, is higher than or equal to 0.5%, or higher than or equal to 1%, or even higher than or equal to 1.25%, or even higher than or equal to 1.5%, and/or lower than or equal to 5%, or even lower than or equal to 3%, or even lower than or equal to 2%;
the content of MgO, in weight percent based on the oxides, may be higher than or equal to 0.5%, or even higher than or equal to 1%, or higher than or equal to 1.6% and, preferably lower than or equal to 4%, preferably lower than or equal to 3.2%;
the content of ZrO₂, in weight percent based on the oxides, is higher than or equal to 45%, or higher than or equal to 50%, or higher than or equal to 55%, or even higher than or equal to 60% and/or lower than or equal to 85%, or lower than or equal to 80% or lower than or equal to 75%, or even lower than or equal to 70%, preferably, the content of ZrO₂, in weight percent based on the oxides is higher than or equal to 55%, preferably higher than or equal to 60% and lower than or equal to 75%, preferably lower than or equal to 70%.
the content of “other oxides”, that is the oxides other than the abovementioned oxides, is lower than or equal to 1%, preferably lower than or equal to 0.6% of the total mass of oxides. It is in fact considered that a total content of “other oxides” that is lower than or equal to 1% does not substantially alter the results obtained;
the “other oxides” are only present in the form of impurities;
the content of oxides may account for more than 99.5%, even more than 99.9%, and even substantially 100% of the total weight of the product;
the product is in the form of a particle, even of a ball, or a set of particles, or balls. These balls and particles may have a size lower than or equal to 4 mm and/or higher than or equal to 5 μm;
preferably, the product is in the form of a ball having a sphericity higher than or equal to 0.7, preferably higher than or equal to 0.8, even more preferably higher than or equal to 0.9;
now the product has a specific gravity higher than or equal to 4, or higher than or equal to 4.5, or higher than or equal to 4.7, or even higher than or equal to 5, or even higher than or equal to 5.2, or higher than or equal to 5.4;
the product has a planetary wear lower than or equal to 3.5%, or lower than or equal to 2.9%, or lower than or equal to 2.5%, or lower than or equal to 2.3%, or lower than or equal to 2.1%, or even lower than or equal to 1.9%.

Planetary wear is defined below.

In a second main embodiment, the invention proposes a molten product having the following chemical composition, in weight percent based on the oxides and for a total of 100%:
(ZrO₂ HfO₂): complement to 100%,
1.5%≦CeO₂≦31%,
0.8%≦Y₂O₃≦8.5%,
0%≦Al₂O₃≦30%,
0.5%≦SiO₂, preferably 2.5%≦SiO₂, even 4%≦SiO₂ and SiO₂≦17.4%, even
SiO₂≦17%, SiO₂≦15%, SiO₂≦10%, or SiO₂≦8%,
0≦TiO₂≦8.5%,
0≦MgO≦6%, and
other oxides≦1%,
   provided that 0≦CeO₂/(ZrO₂+HfO₂)≦0.6 and that Y₂O₃/(ZrO₂+HfO₂)≦0.02.

Preferably, the content of SiO₂, in weight percent based on the oxides is higher than or equal to 2.5%, preferably higher than or equal to 4% and lower than or equal to 17%, preferably lower than or equal to 8%.

The content of CeO₂ may be higher than 6%. Furthermore, insofar as they are not incompatible with 2.5%≦SiO₂≦17.4%, the optional features of the list of product features defined above may be applied, optionally, to this product.

As we shall show in greater detail in the rest of the description, a product according to the invention of this type also represents a good compromise between density and wear resistance.

In a third main embodiment, the invention proposes a molten product having the following chemical composition, in weight percent based on the oxides and for a total of 100%:
(ZrO₂+HfO₂): complement to 100%,
1.5%≦CeO₂≦31%,
0.8%≦Y₂O₃≦8.5%,
0.5%≦Al₂O₃≦30%,
0%≦SiO₂≦37%,
0≦TiO₂≦8.5%,
0≦MgO≦6% and
other oxides≦1%,
   provided that 0≦CeO₂/(ZrO₂+HfO₂)≦0.6 and that Y₂O₃/(ZrO₂+HfO₂)≦0.02.

Preferably, the content of Al₂O₃, in weight percent based on the oxides, is higher than or equal to 1%, preferably higher than or equal to 4% and lower than or equal to 10%, preferably lower than or equal to 8%.

The content of CeO₂ may be higher than 6%. Furthermore, insofar as they are incompatible with 0.5%≦Al₂O₃, the optional features of the list of product features defined above may be applied, optionally, to this product.

As we shall show in greater detail in the rest of the description, a product according to the invention of this type also represents a good compromise between density and wear resistance.

In a fourth main embodiment of the invention, the invention proposes a molten product having the following chemical composition, in weight percent based on the oxides and for a total of 100%:
(ZrO₂+HfO₂): complement to 100%,
1.5≦CeO₂≦31%,
0.8%≦Y₂O₃≦8.5%,
0%≦Al₂O₃≦30%, even 0.5%≦Al₂O₃,
0%≦SiO₂≦37%,
0.5%≦TiO₂≦8.5%,
0≦MgO≦6% and
other oxides≦1%,

provided that 0≦CeO₂/(ZrO₂+HfO₂)≦0.6 and that Y₂O₃/(ZrO₂+HfO₂)≦0.02.

Preferably, the content of TiO₂, in weight percent based on the oxides, is higher than or equal to 1% and lower than or equal to 8.5%, preferably lower than or equal to 5%.

The content of CeO₂ may be higher than 6%. Furthermore, insofar as they are not incompatible with 0.5%≦TiO₂≦8.5%, the optional features of the list of product which is defined above may be applied, optionally, to this product.

As we shall show in greater detail in the rest of the description, a product according to the invention of this type also represents a good compromise between density and wear resistance.

In a fifth main embodiment of the invention, the invention proposes a molten product having the following chemical composition, in weight percent based on the oxides and for a total of 100%;
(ZrO₂+HfO₂): complement to 100%,
6%≦CeO₂≦31%,
0.8%≦Y₂O₃≦8.5%,
0%≦Al₂O₃≦30% even 0.5%≦Al₂O₃,
0%≦SiO₂≦37%,
0≦TiO₂≦8.5%,
0≦MgO≦6% and
other oxides≦1%,
   provided that 0.15≦CeO₂/(ZrO₂+HfO₂)≦0.6 and that Y₂O₃/(ZrO₂+HfO₂)≦0.02.

Furthermore, insofar as they are not incompatible with 0.15≦CeO₂/(ZrO₂+HfO₂), the optional features of the list of product features defined above may be applied, optionally, to this product.

As we shall show in greater detail in the rest of the description, a product according to the invention of this type also represents a good compromise between density and wear resistance.

The invention also relates to a powder comprising more than 80%, more than 90%, even substantially 100% by number of particles, in particular balls of a product according to the invention.

The invention also relates to a powder obtained by grinding particles, in particular balls, according to the invention.

The invention also relates to a method for fabricating a product, comprising the following successive steps:

a) mixing of raw materials to form a starting charge,

b) melting of the starting charge in order to form a melting material, and

c) solidification of the melting material in order to obtain a molten product.

According to this method, the starting charge is determined so that the molten product conforms to any one of the five main embodiments of the invention described above.

The invention also relates to the use of a product according to the invention, obtained for example by a method according to the invention, as a grinding agent, a dispersion agent in wet medium, or for surface treatment, particularly in the applications mentioned in the introduction to the present specification.

In a preferred embodiment of the invention, the products according to the invention, and particularly the molten balls according to the invention, are used without previously having undergone a heat treatment for crystallizing them, even partially, and preferably, are used under conditions not causing such a crystallization.

Definitions
Conventionally, Min(x; y) is equal to the smaller of the values x and y.
“Particle” means an individualized solid product in a powder.
“Ball” means a particle having a sphericity, that is a ratio of its smallest to its largest diameter, higher than or equal to 0.6, regardless of the way in which this sphericity has been obtained.
“Size” of a ball (or a particle) is the mean of its largest dimension dM and its smallest dimension dm: (dM+dm)/2.
“Molten product” means a product obtained by solidification by cooling of a melting material.
“Melting material” is a mass which, to preserve its shape, must be contained in a receptacle. A melting material is generally liquid; however, it may contain solid particles, but in an insufficient quantity for them to structure said mass.
“Impurities” means the inevitable constituents, necessarily introduced with the raw material. In particular, the compounds forming part of the group of oxides, nitrides, oxinitrides, carbides, oxycarbides, carbonitrides and metal species of sodium and other alkalis, iron, vanadium and chromium, are impurities. By way of example, mention can be made of CaO, Fe₂O₃ or Na₂O. Residual carbon is part of the impurities of the composition of the products of the invention.
When reference is made to zirconia or to ZrO₂, this must be understood as (ZrO₂+HfO₂). In fact, a little HfO₂, chemically indissociable from the ZrO₂ in a melting process and having similar properties, is always naturally present in the sources of zirconia in contents generally below 2%. Hafnium oxide is therefore not considered as an impurity.
“Precursor” of an oxide means a constituent capable of supplying said oxide during the fabrication of a product according to the invention.
“Surface treatment” means an operation consisting in changing the state of a surface by mechanical action of particles projected on this surface. The projected particles are solid and do not adhere to the surface. In other words, the term “surface treatment” does not cover applications in which the product is fixed to a surface, in the form of a layer.

All the percentages of the present description are percentages by weight based on the oxides, unless otherwise indicated.

Other features and advantages will appear further from the reading of the description that follows.

### DETAILED DESCRIPTION

Method

To fabricate a product according to an embodiment of the invention, the steps a) to c) mentioned above can be carried out.

These steps are conventional, except for the composition of the starting charge, and a person skilled in the art knows how to adjust them according to the intended application.

A preferred embodiment of this method is now described.

In step a), the starting charge is formed of the oxides desired in the product or of precursors thereof. Preferably, to fabricate a product based on zirconia, natural zircon sand ZrSiO₄ is used, containing about 66% of ZrO₂ and 33% of SiO₂, plus impurities. The addition of ZrO₂ via zircon is in fact much more economical than an addition of ZrO₂.

The compositions can be adjusted by adding pure oxides, mixtures of oxides or mixtures of precursors of these oxides, in particular ZrO₂, SiO₂, CeO₂, Y₂O₃, TiO₂, Al₂O₃.

A person skilled in the art adjusts the composition of the starting charge in order to obtain, on completion of step c), a product having the desired chemical analysis. The chemical analysis of a molten ceramic product is generally substantially identical to that of the starting charge. Furthermore, if necessary, for example to take account of the presence of volatile oxides, or to take account of the loss of SiO₂ when the fusion is carried out under reducing conditions, a person skilled in the art knows how to adjust the composition of the starting charge accordingly.

Preferably, no oxide other than ZrO₂+HfO₂, SiO₂, Y₂O₃, CeO₂, TiO₂ and Al₂O₃ is introduced voluntarily, in the form of oxide or oxide precursor, into the starting charge, the other oxides present thus being impurities.

In step b), the starting charge is melted, preferably in an electric arc furnace. The electrofusion serves in fact to produce large quantities of particles with advantageous yields. However, all known furnaces may be used, such as an induction furnace or a plasma furnace, provided that they are suitable for melting the starting charge to form a bath of melting material.

In step c), a stream of melting liquid is dispersed in small droplets, most of which, due to the surface tension, assume a substantially spherical shape. This dispersion can be carried out by blowing, particularly with air and/or steam, or by any other method for spraying a molten material, known to a person skilled in the art. A molten ceramic particle having a size of 5 μm and 4 mm may thus be produced.

The cooling resulting from the dispersion leads to the solidification of the liquid droplets. Molten particles are thereby obtained, in particular balls.

Any conventional method for fabricating molten particles, particularly molten balls, can be used. For example, it is possible to fabricate a molten and poured block, than to grind it and, if necessary, perform a particle size selection.

Product

The inventors have discovered that in the following ranges of composition:
6%≦CeO₂≦31%,
0.8%≦Y₂O₃≦8.5%,
0%≦Al₂O₃≦30%,
0%≦SiO₂≦37%,
0≦TiO₂≦8.5%,
0≦MgO≦6% and
other oxides≦1%,
(ZrO₂+HfO₂) being the complement to 100%,
   the properties of the product, particularly in terms of wear resistance and/or density, vary according to the Y₂O₃ and (ZrO₂+HfO₂) contents, and more particularly according to the weight ratios Y═Y₂O₃/(ZrO₂+HfO₂) and C≦CeO₂/(ZrO₂+HfO₂).

The inventors have thus found, unexpectedly, that the abovementioned weight ratios Y and C have a major impact on the wear resistance and on the density of the product obtained. They have determined in particular the intervals for the weight ratios Y and C, and also a relation between these ratios, which serve to obtain very good wear resistance and high density.

Thus, according to the first main embodiment,
0≦C≦0.6 and Y≦0.02 and

Min(63.095*Y²−11.214*Y+0.4962; 0.25)≦C (I) and

C≦250*Y²−49.1*Y+2.6 (II).

The properties are further improved when the following conditions are satisfied:

Min(70.238*Y²−12.393*Y+0.544; 0.25)≦C (III) or

C≦150*Y²−30.7*Y+1.72 (IV),

both of these conditions being preferably satisfied.

The conditions (III) and (IV) may in particular be satisfied by a product of the invention comprising between 55% and 75% by weight of (ZrO₂+HfO₂), in weight percent based on the oxides, and a weight ratio Y₂O₃ /(ZrO₂+HfO₂) of between 0.03 and 0.09, preferably between 0.03 and 0.06.

In these preferred embodiments,

Min(−38.095*Y²+0.3571*Y+0.2738; 0.25)≦C (V) and/or

C≦−51.1905*Y²+0.25*Y+0.4826 (VI);

both of these conditions being preferably satisfied. Excellent compromises between density and wear resistance are thereby obtained.

In one embodiment, the weight ratio Y is higher than or equal to 0.02. Y is preferably higher than or equal to 0.03, preferably to 0.04, preferably even to 0.045.

In fact, below this value, the wear resistance may be unsatisfactory in certain applications.

A product according to the invention, obtained for example by a method according to the invention, may have a weight ratio C advantageously of between 0.2 and 0.5, and a weight ratio Y of between 0.03 and 0.06. The compromise between density and wear resistance is then considered as optimal.

Regardless of the embodiment, the weight ratio C is lower than or equal to 0.6. The inventors have in fact found that above this ratio, harmful phases may be formed, such as for example zirconia in cubic crystallographic form.

As indicated above, the weight ratio C may be even higher than or equal to 0.30, or even higher than or equal to 0.40 and/or lower than or equal to 0.55, or lower than or equal to 0.50, or lower than or equal to 0.45 or even lower than or equal to 0.40, or even lower than or equal to 0.35.

The weight ratio Y is preferably lower than or equal to 0.09, preferably lower than or equal to 0.06. In fact, with a ratio Y>0.09, the content of CeO₂ maximizing the density of the product leads to unsatisfactory wear resistances in certain applications.

As stated above, the weight ratio Y may be higher than or equal to 0.025, or higher than or equal to 0.030, or higher than or equal to 0.035, or even higher than or equal to 0.040 and/or lower than or equal to 0.085, or lower than or equal to 0.080, or even lower than or equal to 0.070, or even lower than or equal to 0.060.

In all the embodiments, the product may have one or more of the features of the list of product features above, insofar as these features are not incompatible with these embodiments.

Preferably, the content of CeO₂ is higher than or equal to 6%, preferably to 10%, by weight based on the oxides. These contents serve to obtain particularly high densities. Preferably, the content of CeO₂ is higher than or equal to 10% and the contents of ZrO₂, CeO₂ and of Y₂O₃ satisfy the conditions (III) and (IV), and preferably the conditions (V) and (VI).

The content of CeO₂ is also lower than or equal to 31% by weight based on the oxides. The inventors have in fact found that above this content, the resulting products no longer provide satisfaction, particularly in terms of wear resistance.

As stated above, the content of CeO₂ in weight percent based on the oxides, may be higher than or equal to 8%, or higher than or equal to 10%, or higher than or equal to 10.5%, or higher than or equal to 12%, or higher than or equal to 15%, or higher than or equal to 17% and/or lower than or equal to 30%, or lower than or equal to 28%, or even lower than or equal to 26%, or lower than or equal to 25%, or even lower than or equal to 20%.

The inventors have also found that silica improves the creation of solid product particles, that is, with few internal pores, or even without internal porosity. Preferably, the content of silica is higher than 2.5%. The best performance was obtained with silica contents of between 2.5% and 17%, and even more, between 4% and 8%. However, this favorable effect is reduced if the content of MgO is too high. Preferably, the content of MgO is lower than or equal to 6%.

The inventors have also observed that the presence of alumina and/or titanium dioxide improves the wear resistance of the product. This is why the content of alumina is preferably higher than 0.5%, preferably higher than or equal to 1%, preferably higher than or equal to 4%. Preferably, the content of alumina nevertheless remains lower than 30%, in order to privilege the production of the elements CeO₂ and Y₂O₃ which have a particularly advantageous positive influence. Moreover, higher alumina contents to not improve the wear resistance.

Preferably, the content of TiO₂ is higher than 1%. Preferably, the content of TiO₂ is lower than 8.5%. The inventors have in fact found that above this value, harmful secondary phases based on TiO₂ and ZrO₂ appear, causing a decrease in the wear resistance.

A product according to the invention may advantageously have a specific gravity higher than or equal to 4, or higher than or equal to 4.5, or higher than or equal to 4.7, or even higher than or equal to 5, or even higher than or equal to 5.2, or higher than or equal to 5.4.

A product according to the invention may also advantageously have a planetary wear lower than or equal to 3.5%, or lower than or equal to 2.9%, or lower than or equal to 2.5%, or lower than or equal to 2.3%, or lower than or equal to 2.1%, or even lower than or equal to 1.9%, the planetary wear being measured by the procedure described below in the tests.

The chemical composition of a product according to the invention may cause the product to be suitable for other applications than those described in the present description, particularly as a dry grinding agent, support agent and heat exchange agent.

Tests

Measurement Procedures

The density of the particles according to the invention is measured by a method using a helium pycnometer (AccuPyc 1330 sold by Micromeritics®), according to the method based on the measurement of the volume of gas (in the present case helium) that is displaced.

The following methods allow an excellent simulation of the actual service behavior in grinding applications.

To determine the wear resistance called “planetary” wear, 20 ml (volume measured using a graduated cylinder) of particles to be tested having a size of between 0.8 and 1 mm are weighed (weight m₀) and introduced into one of the 4 bowls coated with dense sintered alumina, having a capacity of 125 ml, of a Retsch make PM400 type rapid planetary mill. 2.2 g of Presi make silicon carbide (having a mean size D50 of 23 μm) and 40 ml of water, are added to one of the bowls. The bowl is closed and rotated (planetary movement) at 400 rpm with reversal of the direction of rotation at one minute intervals for 1 hour 30 minutes. The contents of the bowl are then washed on a 100 μm sieve in order to remove the residual silicon carbide and any material removed due to wear during the grinding. After sieving on a 100 μm sieve, the particles are then dried in the oven at 100° C. for 3 h and then weighed (weight m).

The planetary wear, expressed as a percentage, is given by the following formula:

100(m₀−m)/m₀

Fabrication Protocol

The starting charge used is a composition based on zircon, to which is added yttrium oxide, cerium oxide, aluminum oxide, silicon dioxide and, optionally, zirconium dioxide (zirconia) and titanium dioxide.

More precisely, the charge introduced into a Heroult type electric arc furnace is a powdery composition consisting of zircon sand and other oxides mentioned above, in order to make it melt.

The melting material is poured in the form of a stream, and then dispersed into balls by blowing compressed air.

A plurality of fusion/pouring cycles are carried out by adjusting the composition for the oxides of yttrium, cerium, aluminum, silicon and, optionally zirconium and titanium.

This technique serves to have several batches of balls of different compositions, which can be characterized by methods well known to a person skilled in the art.

Results

The results obtained are given in the following table:

TABLE 1

| | ZrO₂ + | | | | | | Other | Y₂O₃/ | | | |
|---|---|---|---|---|---|---|---|---|---|---|---|
| | HfO₂ | SiO₂ | Y₂O₃ | Al₂O₃ | CeO₂ | TiO₂ | oxides | ZrO₂ | ZrO₂/ | Al₂O₃/ | Formula |
| Ex | in % | in % | in % | in % | in % | in % | in % | (Y) | SiO₂ | SiO₂ | (I) |
| 1(*) | 72.1 | 11.4 | 0.1 | 3.6 | 12.4 | — | 0.5 | 0.0000 | 6.3 | 0.32 | |
| 2(*) | 74.8 | 23.7 | 0.1 | 0.9 | 0 | — | 0.5 | 0.0013 | 3.2 | 0.04 | |
| 3(*) | 68.9 | 29.2 | 0.7 | 0.9 | 0 | — | 0.3 | 0.0102 | 2.4 | 0.03 | |
| 4(*) | 66.3 | 10.3 | 0.9 | 4.3 | 17.8 | — | 0.4 | 0.0136 | 6.4 | 0.42 | |
| 5(*) | 67.5 | 28.9 | 1.4 | 1.9 | 0 | — | 0.3 | 0.0207 | 2.3 | 0.07 | 0.2500 |
| 6(*) | 66 | 29.1 | 1.7 | 2.8 | 0 | — | 0.4 | 0.0258 | 2.3 | 0.10 | 0.2492 |
| 7(*) | 64.6 | 26.8 | 1.7 | 1.4 | 5.1 | — | 0.4 | 0.0263 | 2.4 | 0.05 | 0.2448 |
| 8 | 69.9 | 9.2 | 2.1 | 2.9 | 15.4 | — | 0.5 | 0.0300 | 7.6 | 0.32 | 0.2162 |
| 9⁺⁺ | 63.5 | 6.2 | 2 | 7.6 | 15.7 | 4.4 | 0.6 | 0.0315 | 10.2 | 1.23 | 0.2056 |
| 10⁺⁺ | 57.8 | 8.2 | 1.8 | 2.6 | 28.9 | — | 0.7 | 0.0311 | 7.0 | 0.32 | 0.2082 |
| 11(*) | 75.7 | 11.9 | 2.7 | 9.4 | 0 | — | 0.3 | 0.0357 | 6.4 | 0.79 | 0.1765 |
| 12⁺⁺ | 58.4 | 7.3 | 2.3 | 2.1 | 29.2 | — | 0.7 | 0.0394 | 8.0 | 0.29 | 0.1524 |
| 13⁺⁺ | 72.1 | 4.9 | 2.9 | 4 | 14.5 | 1.2 | 0.4 | 0.0402 | 14.7 | 0.82 | 0.1472 |
| 14(*) | 68.5 | 17.5 | 3 | 0.4 | 10 | — | 0.6 | 0.0438 | 3.9 | 0.02 | 0.1261 |
| 15(*) | 65 | 29 | 3.2 | 2 | 0 | — | 0.8 | 0.0492 | 2.2 | 0.07 | 0.0970 |
| 16 | 66.6 | 16 | 3.3 | 6.7 | 6.7 | — | 0.7 | 0.0495 | 4.2 | 0.42 | 0.0955 |
| 17⁺⁺ | 68 | 12.5 | 3.4 | 4.7 | 10.9 | — | 0.5 | 0.0500 | 5.4 | 0.38 | 0.0932 |
| 18⁺⁺ | 60.1 | 7.5 | 3 | 4.8 | 24 | — | 0.6 | 0.0499 | 8.0 | 0.64 | 0.0936 |
| 19⁺⁺ | 66.4 | 10.5 | 3.5 | 6.5 | 11 | 1.8 | 0.3 | 0.0527 | 6.3 | 0.62 | 0.0804 |
| 20⁺⁺⁺ | 64.6 | 7.2 | 3.5 | 9.5 | 12.9 | 1.9 | 0.4 | 0.0542 | 9.0 | 1.32 | 0.0738 |
| 21⁺⁺⁺ | 65 | 8.2 | 3.5 | 5.5 | 15.4 | 1.8 | 0.6 | 0.0538 | 7.9 | 0.67 | 0.0753 |
| 22⁺⁺⁺ | 65.9 | 4.5 | 3.6 | 5.8 | 17.5 | 2 | 0.7 | 0.0546 | 14.6 | 1.29 | 0.0719 |
| 23⁺⁺⁺ | 64 | 7.2 | 3.5 | 4.2 | 18.5 | 2 | 0.6 | 0.0547 | 8.9 | 0.58 | 0.0716 |
| 24⁺⁺⁺ | 64 | 7.2 | 3.5 | 4.4 | 18.9 | 1.8 | 0.2 | 0.0547 | 8.9 | 0.61 | 0.0716 |
| 25⁺⁺ | 64.5 | 7.6 | 3.6 | 11.2 | 10.8 | 1.9 | 0.4 | 0.0558 | 8.5 | 1.47 | 0.0669 |
| 26⁺⁺⁺ | 64.3 | 7.9 | 3.6 | 9.4 | 14.2 | — | 0.6 | 0.0560 | 8.1 | 1.19 | 0.0661 |
| 27⁺⁺⁺ | 62.9 | 7.4 | 3.5 | 4.8 | 19.2 | 1.7 | 0.5 | 0.0556 | 8.5 | 0.65 | 0.0676 |
| 28⁺⁺⁺ | 61.2 | 4.1 | 3.5 | 4.8 | 23.7 | 2 | 0.7 | 0.0572 | 14.9 | 1.17 | 0.0612 |
| 29(*) | 68.3 | 17.3 | 4.1 | 4.7 | 4.8 | — | 0.8 | 0.0600 | 3.9 | 0.27 | 0.0504 |
| 30 | 55.1 | 4.6 | 3.3 | 5.4 | 28.6 | 2.2 | 0.8 | 0.0599 | 12.0 | 1.17 | 0.0509 |
| 31⁺⁺ | 62.9 | 7.1 | 4.2 | 5.4 | 17.7 | 1.9 | 0.8 | 0.0668 | 8.9 | 0.76 | 0.0287 |
| 32(*) | 53.9 | 2.7 | 3.6 | 4.5 | 32.6 | 2 | 0.7 | 0.0668 | 20.0 | 1.67 | 0.0287 |
| 33(*) | 53 | 4.2 | 3.6 | 4.6 | 31.8 | 2 | 0.8 | 0.0679 | 12.6 | 1.10 | 0.0256 |
| 34(*) | 68.4 | 23.5 | 5.1 | 1 | 1.4 | — | 0.6 | 0.0746 | 2.9 | 0.04 | 0.0108 |
| 35⁺⁺ | 68.7 | 9.4 | 5.5 | 5.2 | 10.3 | — | 0.9 | 0.0801 | 7.3 | 0.55 | 0.0028 |
| 36⁺⁺ | 63.7 | 10.1 | 5.1 | 6.9 | 13.4 | — | 0.8 | 0.0801 | 6.3 | 0.68 | 0.0028 |
| 37(*) | 69.3 | 20.7 | 5.6 | 3.8 | 0 | — | 0.6 | 0.0808 | 3.3 | 0.18 | 0.0020 |
| 38⁺⁺ | 64.4 | 7.8 | 5.8 | 9.8 | 10.3 | 1.4 | 0.5 | 0.0901 | 8.3 | 1.26 | −0.0020 |
| 39 | 67.7 | 8.1 | 6.1 | 3.8 | 12.9 | 1 | 0.4 | 0.0901 | 8.4 | 0.47 | −0.0020 |

| | | | | CeO₂/ | | | | | |
|---|---|---|---|---|---|---|---|---|---|
| | Formula | Formula | Formula | ZrO₂ | Formula | Formula | Formula | Planetary | |
| Ex | (III) | (VII) | (V) | (C) | (II) | (IV) | (VI) | wear (in %) | Density |
| 1(*) | | | | 0.1720 | | | | 11 | 4.9 |
| 2(*) | | | | 0.0000 | | | | 8.6 | 4.2 |
| 3(*) | | | | 0.0000 | | | | 7.7 | 4 |
| 4(*) | | | | 0.2685 | | | | 7.6 | 5.1 |
| 5(*) | 0.2500 | 0.2500 | 0.2500 | 0.0000 | 0.6000 | 0.6000 | 0.4658 | 6 | 4 |
| 6(*) | 0.2500 | 0.2500 | 0.2500 | 0.0000 | 0.6000 | 0.6000 | 0.4551 | 5.6 | 3.9 |
| 7(*) | 0.2500 | 0.2500 | 0.2500 | 0.0789 | 0.6000 | 0.6000 | 0.4537 | 4.8 | 4 |
| 8 | 0.2351 | 0.2300 | 0.2501 | 0.2203 | 0.6000 | 0.6000 | 0.4439 | 2.6 | 5.1 |
| 9⁺⁺ | 0.2233 | 0.2213 | 0.2473 | 0.2472 | 0.6000 | 0.6000 | 0.4397 | 2 | 4.6 |
| 10⁺⁺ | 0.2262 | 0.2234 | 0.2480 | 0.5000 | 0.6000 | 0.6000 | 0.4407 | 2.3 | 5.5 |
| 11(*) | 0.1913 | 0.1960 | 0.2381 | 0.0000 | 0.6000 | 0.6000 | 0.4264 | 3 | 4.6 |
| 12⁺⁺ | 0.1649 | 0.1734 | 0.2288 | 0.5000 | 0.6000 | 0.6000 | 0.4130 | 2.4 | 5.6 |
| 13⁺⁺ | 0.1592 | 0.1683 | 0.2265 | 0.2011 | 0.6000 | 0.6000 | 0.4098 | 2.2 | 5.5 |
| 14(*) | 0.1360 | 0.1469 | 0.2164 | 0.1460 | 0.6000 | 0.6000 | 0.3954 | 2.8 | 4.7 |
| 15(*) | 0.1041 | 0.1154 | 0.1991 | 0.0000 | 0.6000 | 0.5722 | 0.3708 | 3.6 | 3.9 |
| 16 | 0.1024 | 0.1136 | 0.1980 | 0.1006 | 0.6000 | 0.5671 | 0.3693 | 2.5 | 4.6 |
| 17⁺⁺ | 0.0999 | 0.1111 | 0.1964 | 0.1603 | 0.6000 | 0.5600 | 0.3671 | 2.2 | 4.97 |
| 18⁺⁺ | 0.1004 | 0.1116 | 0.1967 | 0.3993 | 0.6000 | 0.5613 | 0.3675 | 2.2 | 5.4 |
| 19⁺⁺ | 0.0859 | 0.0963 | 0.1868 | 0.1657 | 0.6000 | 0.5185 | 0.3535 | 2.1 | 4.9 |
| 20⁺⁺⁺ | 0.0787 | 0.0885 | 0.1813 | 0.1997 | 0.6000 | 0.4970 | 0.3459 | 1.8 | 5.1 |
| 21⁺⁺⁺ | 0.0803 | 0.0902 | 0.1826 | 0.2369 | 0.6000 | 0.5018 | 0.3476 | 1.7 | 5.2 |
| 22⁺⁺⁺ | 0.0766 | 0.0861 | 0.1796 | 0.2656 | 0.6000 | 0.4905 | 0.3435 | 1.7 | 5.5 |
| 23⁺⁺⁺ | 0.0763 | 0.0858 | 0.1794 | 0.2891 | 0.6000 | 0.4897 | 0.3432 | 1.8 | 5.4 |
| 24⁺⁺⁺ | 0.0763 | 0.0858 | 0.1794 | 0.2953 | 0.6000 | 0.4897 | 0.3432 | 1.9 | 5.3 |
| 25⁺⁺ | 0.0711 | 0.0800 | 0.1751 | 0.1674 | 0.6000 | 0.4738 | 0.3371 | 2 | 4.9 |
| 26⁺⁺⁺ | 0.0703 | 0.0792 | 0.1744 | 0.2208 | 0.6000 | 0.4714 | 0.3361 | 1.8 | 5.1 |
| 27⁺⁺⁺ | 0.0719 | 0.0809 | 0.1757 | 0.3052 | 0.6000 | 0.4762 | 0.3380 | 1.9 | 5.3 |
| 28⁺⁺⁺ | 0.0650 | 0.0732 | 0.1696 | 0.3873 | 0.6000 | 0.4549 | 0.3295 | 2.3 | 5.6 |
| 29(*) | 0.0532 | 0.0596 | 0.1580 | 0.0703 | 0.5534 | 0.4176 | 0.3131 | 2.4 | 4.6 |
| 30 | 0.0537 | 0.0602 | 0.1585 | 0.5191 | 0.5561 | 0.4194 | 0.3140 | 3.3 | 5.6 |
| 31⁺⁺ | 0.0296 | 0.0316 | 0.1278 | 0.2814 | 0.4361 | 0.3389 | 0.2711 | 2.1 | 5.3 |
| 32(*) | 0.0296 | 0.0316 | 0.1277 | 0.6048 | 0.4358 | 0.3387 | 0.2709 | 7.9 | 5.7 |
| 33(*) | 0.0263 | 0.0276 | 0.1223 | 0.6000 | 0.4183 | 0.3268 | 0.2634 | 7.4 | 5.6 |
| 34(*) | 0.0104 | 0.0084 | 0.0886 | 0.0205 | 0.3289 | 0.2649 | 0.2167 | 2.5 | 3.9 |
| 35⁺⁺ | 0.0020 | 0.0000 | 0.0582 | 0.1499 | 0.2715 | 0.2236 | 0.1745 | 2 | 5.1 |
| 36⁺⁺ | 0.0020 | 0.0000 | 0.0582 | 0.2104 | 0.2714 | 0.2236 | 0.1745 | 2.4 | 5.1 |
| 37(*) | 0.0012 | 0.0000 | 0.0539 | 0.0000 | 0.2648 | 0.2187 | 0.1685 | 2.14 | 4.2 |
| 38⁺⁺ | −0.0024 | 0.0000 | −0.0030 | 0.1599 | 0.2057 | 0.1718 | 0.0899 | 2.4 | 5.2 |
| 39 | −0.0024 | 0.0000 | −0.0033 | 0.1905 | 0.2056 | 0.1716 | 0.0895 | 2.9 | 5.3 |

(*)example outside the invention
The number of ⁺ corresponds to a level of preference, the examples ⁺⁺⁺ being preferred above all others.

63.095*Y²−11.214*Y+0.4962 or 0.25 if the formula gives a result >0.25 Formula (I):

250*Y²−49.1*Y+2.6 Formula (II):

70.238*Y²−12.393*Y+0.544 or 0.25 if the formula gives a result >0.25 Formula (III):

150*Y²−30.7*Y+1.72 Formula (IV):

−38.095*Y²+0.3571*Y+0.2738 or 0.25 if the formula gives a result >0.25 Formula (V):

−51.1905*Y²+0.25*Y+0.4826 Formula (VI):

859.6102*Y³−93.0079*Y²−2.7284*Y+0.3726 or 0.25 if the formula gives a result >0.25, when Y>0.079 Formula (VII):

The superiority of the products according to the invention clearly appears in the table, by comparison with reference compositions (outside the context of the invention, which are indicated by *).

The products are considered to be particularly efficient when they have both a planetary wear lower than or equal to 2.7 and a specific gravity higher than 4.5 (this refers in particular to products 8 to 10, 12, 13, 16 to 24, 25 to 28, 31, 35, 36 and 38) or when they have both planetary wear lower than 3.4 and a specific gravity higher than 5 (this refers in particular to products 8 to 10, 12, 13, 18, 20 to 24, 26 to 28, 30, 31, 35, 36, 38 and 39).

The reference examples 2, 3, 5, 6, 11, 15, 34 or even 37 particularly demonstrate that an insufficient CeO₂ content does not allow the production of particles having good density. The specific gravity of the resulting particles varies in fact between 3.9 (examples 6, 15 and 34) and 4.6 (example 11).

The reference examples 32 and 33 show that the particles having a CeO₂ content higher than 31% have poor wear resistance (respectively 7.9 and 7.4 for planetary wear).

Obviously, the present invention is not limited to the embodiments described, which are provided as illustrative examples.

1-54. (canceled)

55. A molten product in the form of a particle having a sphericity higher than or equal to 0.6, having the following chemical composition, in weight percent based on the oxides and for a total of 100%:
(ZrO₂+HfO₂): complement to 100%,
6%≦CeO₂≦31%,
0.8%≦Y₂O₃≦8.5%,
0%≦Al₂O₃≦30%,
0.5%≦SiO₂≦17%,
0≦TiO₂≦8.5%,
0≦MgO≦6%, and
other oxides≦1%,
provided that, by denoting by “C” the weight ratio CeO₂/(ZrO₂+HfO₂) and by “Y” the weight ratio Y₂O₃/(ZrO₂+HfO₂),
0≦C≦0.6 and Y≦0.02 and
Min(63.095*Y²−11.214*Y+0.4962; 0.25)≦C (I) and
C≦250*Y²−49.1*Y+2.6 (II).

56. The product as claimed in claim 55, of which the chemical composition satisfies the following condition (III):
Min(70.238*Y²−12.393*Y+0.544; 0.25)≦C (III).

57. A product as claimed in claim 55, in which Y≦0.098.

58. A molten product in the form of a particle having a sphericity higher than or equal to 0.6, having the following chemical composition, in weight percent based on the oxides and for a total of 100%:
(ZrO₂+HfO₂): complement to 100%,
6%≦CeO₂≦31%,
0.8%≦Y₂O₃≦8.5%,
0%≦Al₂O₃≦30%,
0.5%≦SiO₂≦37%,
0≦TiO₂≦8.5%,
0≦MgO≦6%, and
other oxides≦1%,
provided that, by denoting by “C” the weight ratio CeO₂/(ZrO₂+HfO₂) and by “Y” the weight ratio Y₂O₃/(ZrO₂+HfO₂),
0≦C≦0.6 and 0.02≦Y≦0.098 and C≦250*Y²−49.1*Y+2.6 and when Y≦0.079,
Min(859.6102*Y³−93.0079*Y²−2.7284*Y+0.3726; 0.25)≦C (VII).

59. The product as claimed in claim 55, of which the chemical composition satisfies the following condition (V):
Min(−38.095*Y²+0.3571*Y+0.2738; 0.25)≦C (V).

60. The product as claimed in claim 55, of which the chemical composition satisfies the following condition (IV):
C≦150*Y²−30.7*Y+1.72 (IV).

61. The product as claimed in claim 55, of which the chemical composition satisfies the following condition (VI):
C≦−51.1905*Y²+0.25*Y+0.4826 (VI).

62. The product as claimed in claim 55, in which 0.20≦CeO₂/(ZrO₂+HfO₂).

63. The product as claimed in claim 62, in which 0.30≦CeO₂/(ZrO₂+HfO₂).

64. The product as claimed in claim 55, in which the weight ratio CeO₂/(ZrO₂+HfO₂) is lower than or equal to 0.5.

65. The product as claimed in claim 55, in which the content of CeO₂, in weight percent based on the oxides, is higher than or equal to 10%.

66. The product as claimed in claim 55, in which the content of CeO₂, in weight percent based on the oxides, is higher than or equal to 10.5%.

67. The product as claimed in claim 55, in which the content of CeO₂, in weight percent based on the oxides, is higher than or equal to 15%.

68. The product as claimed in claim 55, in which the weight ratio Y₂O₃/(ZrO₂+HfO₂) is higher than or equal to 0.03.

69. The product as claimed in claim 68, in which the weight ratio Y₂O₃/(ZrO₂+HfO₂) is higher than or equal to 0.04.

70. The product as claimed in claim 69, in which the weight ratio Y₂O₃/(ZrO₂+HfO₂) is higher than or equal to 0.045.

71. The product as claimed in claim 55, in which the weight ratio Y₂O₃/(ZrO₂+HfO₂) is lower than or equal to 0.090.

72. The product as claimed in claim 55, in which the weight ratio Y₂O₃/(ZrO₂+HfO₂) is lower than or equal to 0.060.

73. The product as claimed in claim 55, in which the content of Y₂O₃, in weight percent based on the oxides, is higher than or equal to 1.65%.

74. The product as claimed in claim 55, in which the content of Y₂O₃, in weight percent based on the oxides, is lower than or equal to 6.5%.

75. The product as claimed in claim 74, in which the content of Y₂O₃, in weight percent based on the oxides, is lower than or equal to 4.5%.

76. The product as claimed in claim 55, in which the weight ratio (ZrO₂+HfO₂)/SiO₂ is higher than or equal to 1.5.

77. The product as claimed in claim 76, in which the weight ratio (ZrO₂+HfO₂)/SiO₂ is higher than or equal to 4.

78. The product as claimed in claim 77, in which the weight ratio (ZrO₂+HfO₂)/SiO₂ is higher than or equal to10.

79. The product as claimed in claim 55, in which the weight ratio (ZrO₂+HfO₂)/SiO₂ is lower than or equal to 25.

80. The product as claimed in claim 79, in which the weight ratio (ZrO₂+HfO₂)/SiO₂ is lower than or equal to 20.

81. The product as claimed claim 80, in which the weight ratio (ZrO₂+HfO₂)/SiO₂ is lower than or equal to 15.

82. The product as claimed in claim 55, in which the content of SiO₂, in weight percent based on the oxides, is higher than or equal to 2.5%.

83. The product as claimed in claim 82, in which the content of SiO₂, in weight percent based on the oxides, is higher than or equal to 4%.

84. The product as claimed in claim 55, in which the content of SiO₂, in weight percent based on the oxides, is lower than or equal to 8%.

85. The product as claimed in claim 55, in which the weight ratio Al₂O₃/SiO₂ is higher than or equal to 0.2.

86. The product as claimed in claim 85, in which the weight ratio Al₂O₃/SiO₂ is higher than or equal to 0.5.

87. The product as claimed in claim 55, in which the weight ratio Al₂O₃/SiO₂ is lower than or equal to 3.2.

88. The product as claimed in claim 87, in which the weight ratio Al₂O₃/SiO₂ is lower than or equal to 2.

89. The product as claimed in claim 55, in which the content of Al₂O₃, in weight percent based on the oxides, is higher than or equal to 1%.

90. The product as claimed in claim 89, in which the content of Al₂O₃, in weight percent based on the oxides, is higher than or equal to 4%.

91. The product as claimed in claim 55, in which the content of Al₂O₃, in weight percent based on the oxides, is lower than or equal to 10%.

92. The product as claimed in claim 91, in which the content of Al₂O₃, in weight percent based on the oxides, is lower than or equal to 8%.

93. The product as claimed in claim 55, in which the content of TiO₂, in weight percent based on the oxides, is higher than or equal to 1%.

94. The product as claimed in claim 55, in which the content of TiO₂, in weight percent based on the oxides, is lower than or equal to 5%.

95. The product as claimed in claim 94, in which the content of TiO₂, in weight percent based on the oxides, is lower than or equal to 3%.

96. The product as claimed in claim 55, in which the weight ratio MgO/SiO₂ is lower than 1.

97. The product as claimed in claim 96, in which the weight ratio MgO/SiO₂ is lower than 0.77.

98. The product as claimed in claim 55, in which the content of MgO, in weight percent based on the oxides, is higher than or equal to 0.5%.

99. The product as claimed in claim 98, in which the content of MgO, in weight percent based on the oxides, is higher than or equal to 1.6%.

100. The product as claimed in claim 99, in which the content of MgO, in weight percent based on the oxides, is lower than or equal to 4%.

101. The product as claimed in claim 55, in which the content of other oxides, in weight percent based on the oxides, is lower than or equal to 0.6%.

102. The product as claimed in claim 55, having a density higher than or equal to 4.

103. The product as claimed in claim 102, having a density higher than or equal to 4.5.

104. The product as claimed in claim 103, having a density higher than or equal to 4.7.

105. The product as claimed in claim 104, having a density higher than or equal to 5.

106. The product as claimed in claim 105, having a density higher than or equal to 5.2.

107. The product as claimed in claim 55, having a size of between 0.005 and 4 mm.

108. A method for fabricating a product, comprising the following successive steps:
a) mixing of raw materials to form a starting charge,
b) melting of the starting charge in order to form a melting material, and
c) solidification of the melting material in order to obtain a molten product, in which the starting charge is determined so that the molten product conforms to claim 55.

109. A grinding agent, a wet medium dispersion agent, or a surface treatment composition comprising:
a molten product in the form of a particle having a sphericity higher than or equal to 0.6, having the following chemical composition, in weight percent based on the oxides and for a total of 100%:
(ZrO₂+HfO₂): complement to 100%,
6%≦CeO₂≦31%,
0.8%≦Y₂O₃≦8.5%,
0%≦Al₂O₃≦30%,
0%≦SiO₂≦17%,
0≦TiO₂≦8.5%,
0≦MgO≦6%, and
other oxides≦1%,
provided that, by denoting by “C” the weight ratio CeO₂/(ZrO₂+HfO₂) and by “Y” the weight ratio Y₂O₃/(ZrO₂+HfO₂),
0≦C≦0.6 and Y≦0.02 and
Min(63.095*Y²−11.214*Y+0.4962; 0.25)≦C (I) and
C≦250*Y²−49.1*Y+2.6 (II).
